(19) United States
(12) Patent Application Publication
(10) Pub. No.: US 2022/0034722 A1
(43) Pub. Date: Feb. 3, 2022

(54) BLACK BODY RADIATION DEVICE

(71) Applicant: SPECTRUM TECHNOLOGY INC., Taoyuan City (TW)

(72) Inventors: Hsiang-Pin LU, Taoyuan City (TW); Chia-Chia HUANG, Taoyuan City (TW); Chao-Chou YUEH, Taoyuan City (TW); Chia-Jung HSU, Taoyuan City (TW)

(21) Appl. No.: 17/083,473

(22) Filed: Oct. 29, 2020

(30) Foreign Application Priority Data
Jul. 29, 2020 (TW) 109125662

(51) Int. Cl. G01J 5/52

(52) U.S. Cl. CPC G01J 5/522; G01J 2005/0048

(57) ABSTRACT

A black body radiation device is provided, which can be used as a benchmark heat source for “thermal imager” temperature detection device. The black body radiation device includes: a heat source module comprising a heater and a temperature equalizing plate, wherein the temperature equalizing plate contacts the heater; a temperature control module connected to the heater to control the heater, thereby keeping the temperature equalizing plate at a predetermined temperature; and a housing configured to accommodate the heat source module and the temperature control module, the housing having an opening, wherein the opening is configured to expose the temperature equalizing plate.

### CROSS REFERENCE TO RELATED APPLICATIONS

This application claims the priority of Taiwan Patent Application No. 109125662, filed on Jul. 29, 2020, titled “BLACK BODY RADIATION DEVICE”, and the disclosure of which is incorporated herein by reference.

### FIELD OF INVENTION

The present invention relates to a calibration device for temperature detection by using thermal radiation, and more particularly, to a black body radiation device.

### BACKGROUND OF INVENTION

In order to prevent the infection of respiratory diseases, non-contact measurement methods are often used to measure the body temperature of people, and the most common method is a “thermal imager” temperature detection device, such as the measurement is performed by using an infrared thermal imaging camera. However, taking the infrared thermal imaging camera as an example, the temperature calibration of the infrared thermal imaging camera requires complicated procedures, and the calibration device uses a thermoelectric cooling module which requires the use of high current and cooling fans to maintain the calibration device operating normally. Therefore, the existing calibration device is bulky and unsuitable for carrying, so the temperature calibration of the infrared thermal imaging camera is performed in a place where external environmental factors are controlled (such as, a laboratory).

The calibrated infrared thermal imaging camera is still affected by factors, such as the ambient temperature and the humidity of the measurement location, the detection distance, the object emissivity, and others, resulting in measurement errors/offsets, such as 0.5° C. Such deviations seriously affect the interpretation of body temperature. For example, a deviation of 0.5° C. affects the reading interpretation which could mean fever, and could cause completely different results.

Therefore, it is necessary to provide a black body radiation device as a benchmark heat source of the thermal imager temperature detection device, to solve the problems in the conventional technology.

### SUMMARY OF INVENTION

An object of the present disclosure is to provide a black body radiation device, which has the characteristics of portable and easy setup. In this way, the black body radiation device provided by the present disclosure can be installed at the measurement location, and used as a benchmark heat source of a thermal imager temperature detection device, and the benchmark heat source is used to compensate for measurement errors/offsets caused by external environmental factors. This can greatly improve the stability and accuracy of body temperature measurement, thereby reducing the misjudgment of people's body temperatures.

In order to achieve the above objects, the present disclosure provides a black body radiation device, which is composed of: a heat source module having a heater and a temperature equalizing plate, wherein the temperature equalizing plate contacts the heater; a temperature control module connected to the heater to control the heater, thereby keeping the temperature equalizing plate at a predetermined temperature; and a housing configured to accommodate the heat source module and the temperature control module, the housing having an opening, wherein the opening is configured to expose the temperature equalizing plate.

In one embodiment of the present disclosure, a material of the temperature equalizing plate comprises copper, aluminum, graphene, or ceramic material.

In one embodiment of the present disclosure, a surface of the temperature equalizing plate exposed to the opening is subjected to a roughening treatment.

In one embodiment of the present disclosure, a surface of the temperature equalizing plate exposed to the opening has a carbon nanotube film.

In one embodiment of the present disclosure, the temperature control module consists of: a temperature sensor configured to sense an actual temperature of the temperature equalizing plate; a microprocessor connected to the temperature sensor, and configured to control an amount of heat generated by the heater according to the actual temperature; and a user interface connected to the microprocessor to set the predetermined temperature.

In one embodiment of the present disclosure, the black body radiation device further consists of: a power supply module configured to provide electric power required by the heat source module and the temperature control module.

In one embodiment of the present disclosure, the power supply module is connected to an external power source to provide the electric power required by the heat source module and the temperature control module.

The present disclosure further provides a black body radiation device, including: a first heat source module comprising a first heater and a first temperature equalizing plate, wherein the first temperature equalizing plate contacts the first heater; a second heat source module separated from the first heat source module, the second heat source module comprising a second heater and a second temperature equalizing plate, wherein the second temperature equalizing plate contacts the second heater; a temperature control module connected to the first heater and the second heater respectively, to control the first heater and the second heater, thereby keeping the first temperature equalizing plate at a first predetermined temperature and keeping the second temperature equalizing plate at a second predetermined temperature; and a housing configured to accommodate the first heat source module, the second heat source module, and the temperature control module, the housing has at least one opening, wherein the opening is configured to expose the first temperature equalizing plate and the second temperature equalizing plate.

In one embodiment of the present disclosure, the first predetermined temperature is different from the second predetermined temperature.

In one embodiment of the present disclosure, the black body radiation device further includes: a power supply module providing a direct current power to drive the first heat source module, the second heat source module, and the temperature control module.

As described above, the black body radiation device provided by the present disclosure controls the heater by the temperature control module, so that the temperature equalizing plate presents the predetermined temperature. Because the heater only has a heating function, and the heat generated by the heater is radiated to the external environment through the temperature equalizing plate, the temperature equalizing plate can be stably maintained at the predetermined temperature, and then the temperature equalizing plate can be used as a stable benchmark heat source. In addition, the present disclosure dissipates heat to the external environment (cooling) by thermal radiation, and there is no need to use high current and cooling fans, thereby reducing the volume and weight. In this way, the present disclosure is portable and can be installed at the measurement location, to reduce measurement errors/offsets caused by external environmental factors, and facilitate to the immediate interpretation of the body temperature at the measurement location.

### DESCRIPTION OF DRAWINGS

In order to more clearly illustrate the technical solutions in the embodiments or the prior art, the following drawings, which are intended to be used in the description of the embodiments or the prior art, will be briefly described. It will be apparent that the drawings and the following description are only some embodiments of the present invention. Those of ordinary skill in the art may, without creative efforts, derive other drawings from these drawings.

FIG. 1 is a structural schematic diagram of a black body device according to an embodiment of the present disclosure.

FIG. 2 is an exploded structural diagram of the embodiment in FIG. 1.

FIG. 3 is an exploded structural diagram of a black body device according to another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the figure(s) being described. As such, the directional terminology is used for purposes of illustration and is in no way limiting. Throughout this specification and in the drawings like parts will be referred to by the same reference numerals.

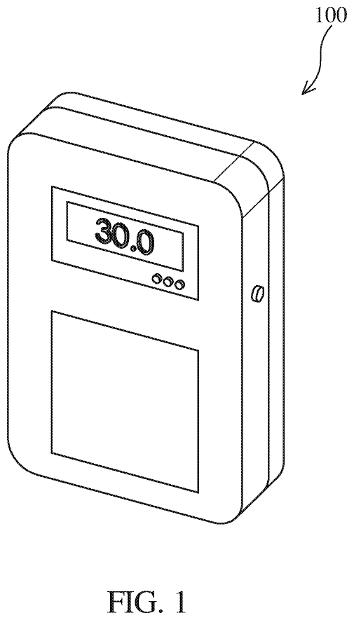

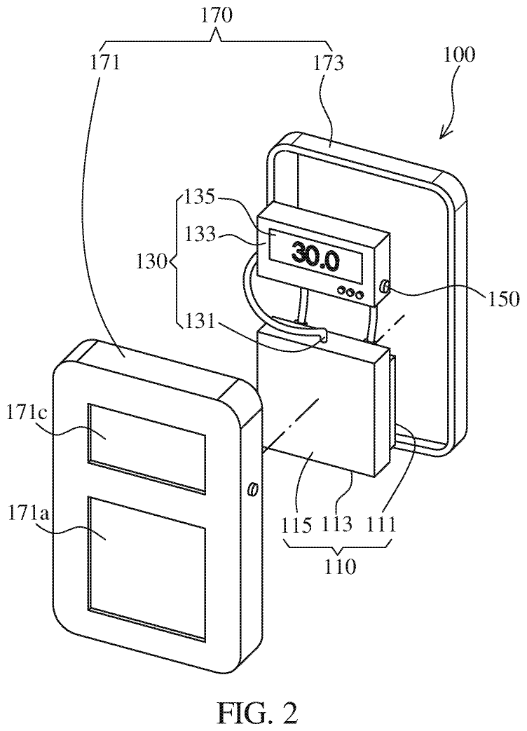

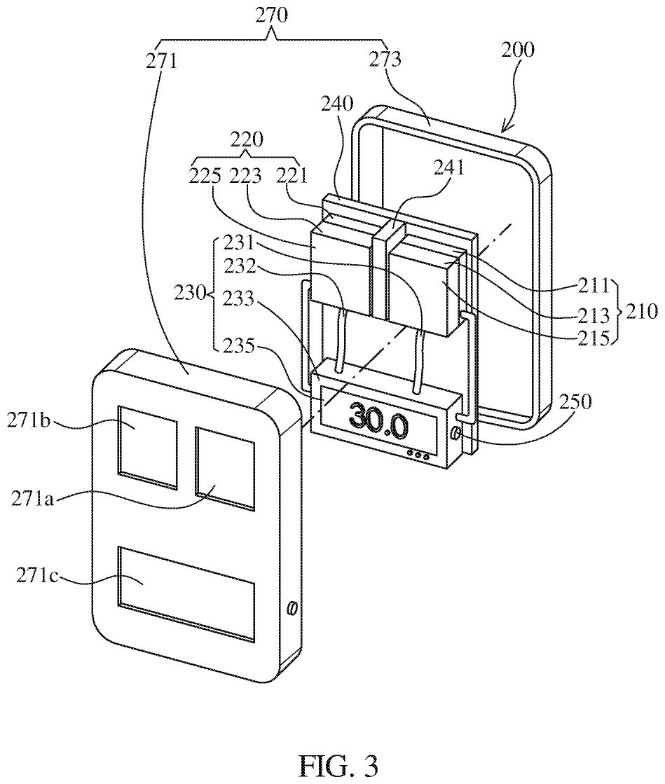

Please refer to FIG. 1 to FIG. 3, FIG. 1 is a structural schematic diagram of a black body device according to an embodiment of the present disclosure. FIG. 2 is an exploded structural diagram of the embodiment in FIG. 1. FIG. 3 is an exploded structural diagram of a black body device according to another embodiment of the present disclosure.

As shown in FIG. 1 and FIG. 2, an embodiment of the present disclosure provides a black body radiation device, consisting of a heat source module 110, a temperature control module 130, a power supply module 150, and a housing 170. The housing 170 is configured to accommodate the heat source 110, the temperature control module 130, and the power supply module 150. The power supply module 150 is configured to provide electric power required by the heat source module 110 and the temperature control module 130.

The heat source module 110 is composed of a heater 111 and a temperature equalizing plate 113, wherein the temperature equalizing plate 113 contacts the heater 111. The heater 111 converts electric power from the power supply module 150 into heat, and the heater 111 may be a flexible ultra-thin electric heating sheet, a thermoelectric cooling chip or other components that convert electrical energy into heat. The temperature equalizing plate 113 may be made of red copper, and the temperature equalizing plate may include the material with excellent thermal conductivity such as copper, aluminum, graphene, or ceramic material. It should be understood that the temperature equalizing plate 113 may also be made by combining various materials with excellent thermal conductivity.

The temperature control module 130 is connected to the heater 111 to control the heater 111, thereby keeping the temperature equalizing plate 113 at a predetermined temperature. The temperature control module 130 may include a temperature sensor 131, a microprocessor 133, and a user interface 135. The temperature sensor 131 is connected to the temperature equalizing plate 113, and is configured to sense an actual temperature of the temperature equalizing plate 113. The microprocessor 133 is connected to the temperature sensor 131 and the heater 111, and the microprocessor 133 is configured to control an amount of heat generated by the heater 111 according to the actual temperature. For example, when the actual temperature is greater than the predetermined temperature, the microprocessor 133 suspends the power supply module 150 from providing electric power to the heater 111; conversely, when the actual temperature is lower than the predetermined temperature, the microprocessor 133 resumes the power supply module 150 to provide the electric power to the heater 111, so as to reduce or increase the amount of heat generated by the heater 111. The user interface 135 is connected to the microprocessor 133, and a user sets the predetermined temperature through the user interface 135. The user interface 135 may include a display to present the predetermined temperature or other related information. The display may be a light emitting diode (LED) display, an organic light emitting diode (OLED) display or other types of displays, such as a touch display. In addition, the user interface 135 may also turn on/off the black body radiation device 100. It should be understood that the connection between the temperature sensor 131, the microprocessor 133, and the user interface 135 may be realized by various types of connecting ports (such as, parallel ports, serial ports), which are not redundantly described herein.

The housing 170 has an opening, wherein the opening is configured to expose the temperature equalizing plate 113. As shown in FIG. 2, the housing 170 may include a front case 171 and a back cover 173, and the front case 171 is provided with an opening 171a to expose a surface 115 of the temperature equalizing plate 113. In this way, the temperature equalizing plate 113 may stably dissipate heat to the external environment at the predetermined temperature by thermal radiation, so as to serve as a benchmark heat source. The front case 171 may also be provided with an information window 171c to display the information presented by the user interface 135. In addition, the surface 115 of the temperature equalizing plate 113 exposed to the opening 171a may be subjected to a roughening treatment or may have a carbon nanotube film, thereby reducing the reflectivity of the temperature equalizing plate 113 and increasing the emissivity. It should be understood that other surfaces of the first surface 215 and the second surface 225 may also be subjected to a roughening treatment or may have a carbon nanotube film. The housing 170 may be made of metal materials. For example, the front case 171 and the back cover 173 are made of aluminum alloy to protect the modules and components accommodated in the housing 170. In addition, the housing 170 may also be made of other suitable materials as required.

The power supply module 150 may provide electric power required by the heat source module 110 and the temperature control module 130 in various ways. The power supply module 150 may be a power input terminal connected to an external power source to provide the electric power required by the heat source module 110 and the temperature control module 130. Specifically, for example, an external alternating current power with 110/220 volts (110/220 VAC) is converted into a direct current power with 5 volts (5 VDC) for the use of the heat source module 110 and the temperature control module 130. It should be understood that the power supply module 150 of present embodiment may also convert an alternating current power with different voltages into a direct current power suitable for use. In addition, the power supply module 150 may also include a power storage component (not shown) to store electric power, such as a battery, so that the present embodiment may also be operated without the external power source. It should be understood that the power storage component may also be other components with power storage function.

The present embodiment provides a benchmark heat source, so that when the thermal imager temperature detection device is operated at the external environment, the measurement offsets caused by external environmental factors can be immediately calibrated, thereby improving the stability and accuracy of body temperature measurements.

As shown in FIG. 3, another embodiment of the present disclosure provides a black body radiation device 200, being composed of a first heat source module 210, a second heat source module 220, a temperature control module 230, a power supply module 250 and a housing 270. The housing 270 is configured to accommodate the first heat source module 210, the second heat source module 220, the temperature control module 230, and the power supply module 250. The power supply module 250 is configured to provide electric power required by the first heat source module 210, the second heat source module 220, and the temperature control module 230.

The first heat source module 210 includes a first heater 211 and a first temperature equalizing plate 213, wherein the first temperature equalizing plate 213 contacts the first heater211. The second heat source module 220 is separated from the first heat source module 210. The second heat source module 220 includes a second heater 221 and a second temperature equalizing plate 223, wherein the second temperature equalizing plate 223 contacts the second heater 221. The first heater 211 and the second heater 221 may respectively convert electric power from the power supply module 250 into heat. The first heater 211 and the second heater 221 may be separately disposed on a heat insulating pad 240, and the heat insulating pad 240 may prevent the first heater 211 and the second heater 221 from affecting each other, and prevent heat loss. In addition, a heat insulating pad 241 may be disposed between the first heat source module 210 and the second heat source module 220 to prevent heat dissipated from the first heat source module 210 and the second heat source module 220 from affecting each other. The first heater 211 and the second heater 221 may be flexible ultra-thin electric heating sheets, thermoelectric cooling chips or other components that convert electrical energy into heat. The first temperature equalizing plate 213 and the second temperature equalizing plate 223 may be made of copper, or be made of the material with excellent thermal conductivity, such as aluminum, graphene, or ceramic material. It should be understood that the first temperature equalizing plate 213 and the second temperature equalizing plate 223 may also be made by combining various materials with excellent thermal conductivity.

The temperature control module 230 is connected to the first heater 211 and the second heater 221 respectively, to control the first heater 211 and the second heater 221, thereby keeping the first temperature equalizing plate 213 at a first predetermined temperature and keeping the second temperature equalizing plate 223 at a second predetermined temperature. The temperature control module may include a first temperature sensor 231, a second temperature sensor 232, a microprocessor 233, and a user interface 235.

The first temperature sensor 231 is connected to the first temperature equalizing plate 213, and is configured to sense a first actual temperature of the first temperature equalizing plate 213. The second temperature sensor 232 is connected to the second temperature equalizing plate 223, and is configured to sense a second actual temperature of the second temperature equalizing plate 223. The microprocessor 233 controls respectively an amount of first heat generated by the first heater 211 and an amount of second heat generated by the second heater 221. For example, when the first actual temperature is greater/lower than the first predetermined temperature, the microprocessor 233 suspends/resumes the power supply module 250 to provide electric power to the first heater 211, thereby keeping the first temperature equalizing plate 213 at the first predetermined temperature. Keeping the second temperature equalizing plate 223 at the second predetermined temperature may also be achieved by using similar operations, which are not repeated herein.

The user interface 235 is connected to the microprocessor 233. A user may set the first predetermined temperature and the second predetermined temperature through the user interface 235 and turn on/off the black body radiation device through the user interface 235. The user interface 235 may include a display to present the first predetermined temperature, the second predetermined temperature, or other related information. It should be understood that the connection between the first temperature sensor 231, the second temperature sensor 232, the microprocessor 233, and the user interface 235 may be realized by various types of connecting ports (such as, parallel ports, serial ports), which are not redundantly described here.

The housing 270 includes a front case 271 and a back cover 273, and the front case 271 is provided with a first opening 271a and a second opening 271b, wherein the first opening 271a is configured to expose a first surface 215 of the first temperature equalizing plate 213 and the second opening 271b is configured to expose a second surface 225 of the second temperature equalizing plate 223. The first surface 215 and the second surface 225 may be subjected to a roughening treatment or may have a carbon nanotube film, thereby reducing the reflectivity of the temperature equalizing plates and increasing the emissivity. It should be understood that the surfaces of the first surface 215 and the second surface 225 may also be subjected to a roughening treatment or may have a carbon nanotube film. The housing 270 may further include an information window 271c to display the information presented by the user interface 235. The housing 270 may be made of metal materials, such as aluminum alloy or other suitable metal materials. In addition, the housing 270 may also be made of other suitable materials as required, such as rigid plastic.

The power supply module 250 may provide a direct current power, such as a direct current power with 5 volts (5 VDC), to drive the first heat source module 210, the second heat source module 220, and the temperature control module 230. The power supply module 250 may convert an external alternating current power with 110/220 volts (110/220 VAC) into a direct current power with 5 volts (5 VDC). In this way, the present disclosure can be used at a measurement location providing an alternating current power with 110/220 volts, such as indoors. The power supply module 250 may also be connected to an external power source that provides a direct current power with 5 volts (5 VDC), such as a mobile power bank, so that the present embodiment may also be operated in a place where an alternating current power with 110/220 volts is not provided, such as be operated in an outdoor passage. It should be understood that the present embodiment may also be operated by direct currents power with different voltages.

When the embodiment in FIG. 3 is in operation, the first predetermined temperature of the first temperature equalizing plate 213 is different from the second predetermined temperature of the second temperature equalizing plate 223. The embodiment can provide two benchmark heat sources with different temperatures so that when the thermal imager temperature detection device is operated at the external environment, the measurement offsets caused by external environmental factors can be immediately calibrated, and a temperature gain can also be immediately calibrated. In addition, the embodiment of the present disclosure may further include a third heat source module (not shown), and the operation principle of the third heat source module is same as the above and is not repeated herein. The third heat source module may be used as the third benchmark heat source. Based on three benchmark heat sources, a temperature curvature can be immediately calibrated by the embodiment of the present disclosure. The foregoing embodiments can improve the stability and accuracy of body temperature measurement.

As described above, the black body radiation device provided by the present disclosure controls the heater by the temperature control module, so that the temperature equalizing plate presents the predetermined temperature. Because the heater only has a heating function, and the heat generated by the heater is radiated to the external environment through the temperature equalizing plate, the temperature equalizing plate can be stably maintained at the predetermined temperature, and then the temperature equalizing plate can be used as a stable benchmark heat source. In addition, the present disclosure dissipates heat to the external environment (cooling) by thermal radiation, and there is no need to use high current and cooling fans, thereby reducing the volume and weight. In this way, the present disclosure is portable and can be installed at the measurement location, to reduce measurement errors/offsets caused by external environmental factors, and facilitate to the immediate interpretation of the body temperature at the measurement location.

In view of the above, although the present invention has been disclosed by way of preferred embodiments, the above preferred embodiments are not intended to limit the present invention, and one of ordinary skill in the art, without departing from the spirit and scope of the invention, the scope of protection of the present invention is defined by the scope of the claims.

What is claimed is:

1. A black body radiation device, comprising:
a heat source module comprising a heater and a temperature equalizing plate, wherein the temperature equalizing plate contacts the heater;
a temperature control module connected to the heater to control the heater, thereby keeping the temperature equalizing plate at a predetermined temperature; and
a housing configured to accommodate the heat source module and the temperature control module, the housing having an opening, wherein the opening is configured to expose the temperature equalizing plate.

2. The black body radiation device according to claim 1, wherein a material of the temperature equalizing plate comprises copper, aluminum, graphene, or ceramic material.

3. The black body radiation device according to claim 1, wherein a surface of the temperature equalizing plate exposed to the opening is subjected to a roughening treatment.

4. The black body radiation device according to claim 1, wherein a surface of the temperature equalizing plate exposed to the opening has a carbon nanotube film.

5. The black body radiation device according to claim 1, wherein the temperature control module comprises:
a temperature sensor configured to sense an actual temperature of the temperature equalizing plate;
a microprocessor connected to the temperature sensor, and configured to control an amount of heat generated by the heater according to the actual temperature; and
a user interface connected to the microprocessor to set the predetermined temperature.

6. The black body radiation device according to claim 1, further comprising: a power supply module configured to provide electric power required by the heat source module and the temperature control module.

7. The black body radiation device according to claim 6, wherein the power supply module is connected to an external power source to provide the electric power required by the heat source module and the temperature control module.

8. A black body radiation device, comprising:
a first heat source module comprising a first heater and a first temperature equalizing plate, wherein the first temperature equalizing plate contacts the first heater;
a second heat source module separated from the first heat source module, the second heat source module comprising a second heater and a second temperature equalizing plate, wherein the second temperature equalizing plate contacts the second heater;
a temperature control module connected to the first heater and the second heater respectively, to control the first heater and the second heater, thereby keeping the first temperature equalizing plate at a first predetermined temperature and keeping the second temperature equalizing plate at a second predetermined temperature; and
a housing configured to accommodate the first heat source module, the second heat source module, and the temperature control module, the housing has at least one opening, wherein the opening is configured to expose the first temperature equalizing plate and the second temperature equalizing plate.

9. The black body radiation device according to claim 8, wherein the first predetermined temperature is different from the second predetermined temperature.

10. The black body radiation device according to claim 8, further comprising: a power supply module providing a direct current power to drive the first heat source module, the second heat source module, and the temperature control module.
